(19) United States
(12) Patent Application Publication
(10) Pub. No.: US 2010/0074387 A1
(43) Pub. Date: Mar. 25, 2010

(54) Frequency to Phase Converter with Uniform Sampling for all Digital Phase Locked Loops

(75) Inventors: Stefan Mendel, Graz (AT); Christian Vogel, Graz (AT)

Correspondence Address: LEE & HAYES, PLLC, 601 W RIVERSIDE AVENUE, SUITE 1400, SPOKANE, WA, 99201, US

(73) Assignee: Infineon Technologies AG, Neubiberg (DE)

(21) Appl. No.: 12/237,245

(22) Filed: Sep. 24, 2008

(51) Int. Cl. H04L 7/00

(52) U.S. Cl. 375/376; 375/371; 341/50

(57) ABSTRACT

This disclosure relates to systems and methods for frequency to phase conversion using uniform sampling, where a uniform or constant clock period is used.

### BACKGROUND

Phase locked loops (PLL) are control systems that generate signals having a fixed relation to the phase of a reference signal. Typically, a phase-locked loop circuit responds to both the frequency and the phase of input signals, raising or lowering the frequency of a controlled oscillator until an oscillator signal is matched with a reference signal in both frequency and phase. Phase-locked loops are widely used in radio, telecommunications, computers, and other electronic applications.

The use of “all-digital phase locked loops” or ADPLLs has become popular. An ADPLL may include the advantages of digital circuits, such as lower power consumption, flexibility, better noise immunity, capability of digital signal processing, so on. A typical ADPLL may include a phase detector, a loop filter, and a digitally controlled oscillator (DCO). In addition, an ADPLL may also include a feedback path from the DCO to the phase detector. The feedback path enables the ADPLL to determine errors in the phase of a generated signal, and to correct such errors. The DCO produces the generated signal with a variable frequency in response to a digital tuning word.

Generally, in the feedback path, the generated (or variable) signal may be converted into a phase signal or a variable phase, for error determination. The variable phase signal is compared to the reference phase signal. The variable phase signal and the reference phase signal should both be in the same clock domain; however, since the frequency of the reference signal and the frequency of the generated signal may not be equal, two clock domains may exist, and in particular, a reference frequency domain and a variable frequency domain.

In order to compare the phases of the variable phase signal and the reference phase signal, the signals may be synchronized. If the signals are not synchronized, the phase of the reference frequency signal may be extracted before it is compared to the phase of the generated signal. To this end, the reference phase signal may be over-sampled by the higher rate variable clock. The resulting retimed reference signal, which is in a third clock domain, is used as a clock for the entire ADPLL.

The reference frequency signal and the variable frequency signal may be converted into phase signals using a frequency to phase converter. A phase error signal may be obtained by subtracting the two signals (i.e., reference phase signal and variable phase signal) using a phase detector. The phase error signal may then be filtered by a loop filter, normalized to make it independent of the DCO gain (and process, voltage, and temperature or “PVT”), and sent to the DCO.

Since three different clock domains (i.e., the reference clock, the variable clock, and the retimed reference clock) are used to compare the two phases, the present phase of the output signal is not exactly known. Since the retimed reference signal has variable shifts, side spurs may appear in the output spectrum. Side spurs may be generated, because the ADPLL operates with a retimed reference clock that is used for the frequency to phase conversion in the feedback path. The retimed reference clock is a delayed version of the reference clock, such that one retimed reference period is an integer multiple of a variable period.

Operating the ADPLL with the retimed reference clock is similar to using a non-uniform sampling frequency, which introduces side spurs. In order to generate a frequency that is a fractional multiple, for example 150¼, of the reference frequency, the retimed reference clock exhibits in one retimed reference cycle 151 variable periods, and in each of the consequent 3 retimed reference cycles, 150 variable periods. On average the ratio will be 150¼.

An issue may be that reference spurs and side spurs may be introduced by injection pulling phenomena. Since an oscillator (i.e., DCO) is not entirely separated from the digital part on the die, the noise of the digital circuit affects the oscillation of the DCO. The digital noise “pulls” the oscillation frequency at rate of the non-uniform retimed reference clock, which introduces besides the reference spurs at multiples of the reference frequency additional spurs, called side spurs.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a block diagram illustrating an exemplary receiver with an “all-digital phase locked loop” or ADPLL.

FIG. 2 is a block diagram illustrating an exemplary “all-digital phase locked loop” or ADPLL with uniform sampling.

FIG. 3 is a block diagram illustrating an “all-digital phase locked loop” or ADPLL with uniform sampling in detail.

FIG. 4 is a chart illustrating an exemplary timing diagram of a reference signal and a variable signal.

FIG. 5 is a chart illustrating an exemplary timing diagram of an “all-digital phase locked loop” or ADPLL with uniform sampling.

FIG. 6 is a flowchart illustrating a process to convert a frequency feedback signal into a phase signal using uniform sampling.

### DETAILED DESCRIPTION

This disclosure is directed towards techniques and methods for converting frequency signals into phase signals using a uniform sampling frequency for an “all-digital phase locked loop” or ADPLL. The ADPLL may be implemented in wireless communication systems, Bluetooth devices, ultra wideband devices, and so on.

The ADPLL may include a phase detector, a loop filter, a digitally controlled oscillator (DCO), and a feedback path with a frequency to phase converter with uniform sampling, where a reference signal includes constant clock periods. The phase detector compares phases of a reference phase signal with a variable feedback phase signal, and generates an error phase signal. The loop filter stabilizes the loop and filters the phase error signal of the phase detector. The DCO may generate a range of frequencies from a fixed time base signal. The DCO generates a variable frequency signal dependent on the error phase signal and the ratio between the variable frequency and the reference frequency may be a fractional number. The variable frequency signal is fed back to the phase detector through the feedback path.

The frequency to phase converter may be implemented in the feedback path of the ADPLL to convert the generated frequency signal back into a phase signal in order for its phase to be compared with the reference phase signal.

The uniform frequency to phase converter may convert frequency signals into phase signals synchronously with use of two clock domains. The phase of the variable frequency signal is extracted with each reference cycle. Thus, the entire ADPLL may be operated with the reference frequency which is uniform instead of the non-uniform retimed reference clock. In other words, a constant or uniform clock period is used. Since the ADPLL avoids re-timing (i.e., non-uniform clock period) of the reference signal (i.e., uniform clock period), side spurs may be eliminated.

In an implementation, the uniform frequency to phase converter separates, and converts, the variable phase signal into an integer variable phase and a fractional variable phase part. The integer phase signal may be derived by first accumulating digital “one” values (i.e., “1”) at the variable frequency signal rate and then re-sampling the accumulated signal with the reference signal. Accumulating “one” values at the generated frequency signal converts the analog frequency signal into a digital phase signal. The digital phase signal, which is denoted as the integer variable phase, is then re-sampled at the reference signal frequency for synchronization. The accumulated number in each reference cycle corresponds to the number of complete cycles of variable periods plus one.

The fractional phase signal may be obtained by first comparing the reference signal and the generated signal using a time to digital converter (TDC). The TDC determines the difference between the phases of the signals and generates a digital output. The digital output may be used to calculate the fractional phase signal. In specific, the TDC output is normalized to one period of variable frequency signal. The normalization is required, because the integer phase is intrinsically similarly normalized.

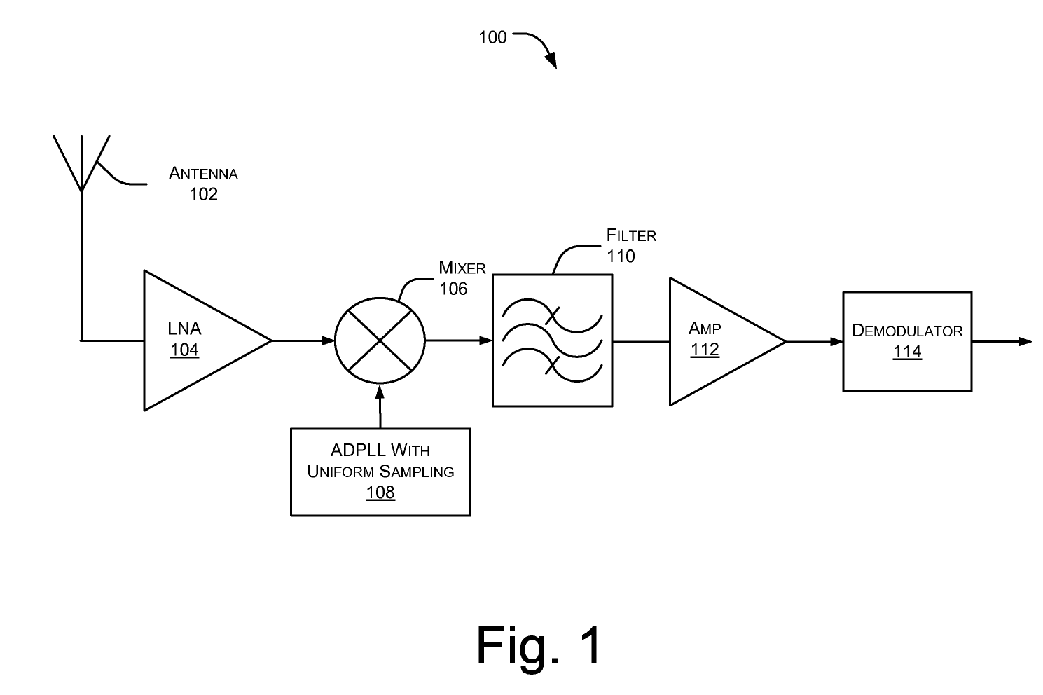

FIG. 1 illustrates an exemplary system 100 that employs the ADPLL with a uniform sampling frequency to phase converter. The exemplary system 100 may be implemented in a variety of communication systems. For example, system 100 may be implemented in wireless communication systems, mobile communication systems, Bluetooth systems, and so on. The following exemplary system 100 is described with reference to a communication receiver that may be implemented in communication systems.

It is to be appreciated that the order in which the block diagram of FIG. 1 and other block diagrams that are described, is not intended to be construed as a limitation, and any number of the described blocks of system 100 may be combined in any order to implement the system 100, or an alternate system. Furthermore, individual blocks may be deleted from the system without departing from the spirit and scope of the subject matter described herein. The system 100 may be implemented in any suitable hardware or device without departing from the scope of the invention.

The system 100 may be a communication receiver. To this end, the exemplary system 100 includes an antenna 102, one or more low noise amplifiers (LNA) 104, one or more mixers 106 along with an ADPLL with uniform sampling or ADPLL 108, one or more filters 110, amplifiers 112, and a demodulator 114. In certain implementations, such as “two point modulation”, the mixers 106 may not be used.

The antenna 102 may receive an analog audio signal or a digital signal. The received signal may be in the radio frequency or RF band. The received RF signal is amplified using LNA 104. In an implementation, the LNA 104 amplifies weak signals captured by the antenna 102. The LNA 104 may be placed at the front-end of the system 100. The LNA 104 reduces the noise of the subsequent stages, but inherent noise of the LNA 104 may be added directly into the signal received by the antenna 102. Therefore, it may be necessary for the LNA 104 to boost the desired signal power while adding as little noise and distortion as possible, such that the retrieval of the signal is possible in the following stages of the system 100.

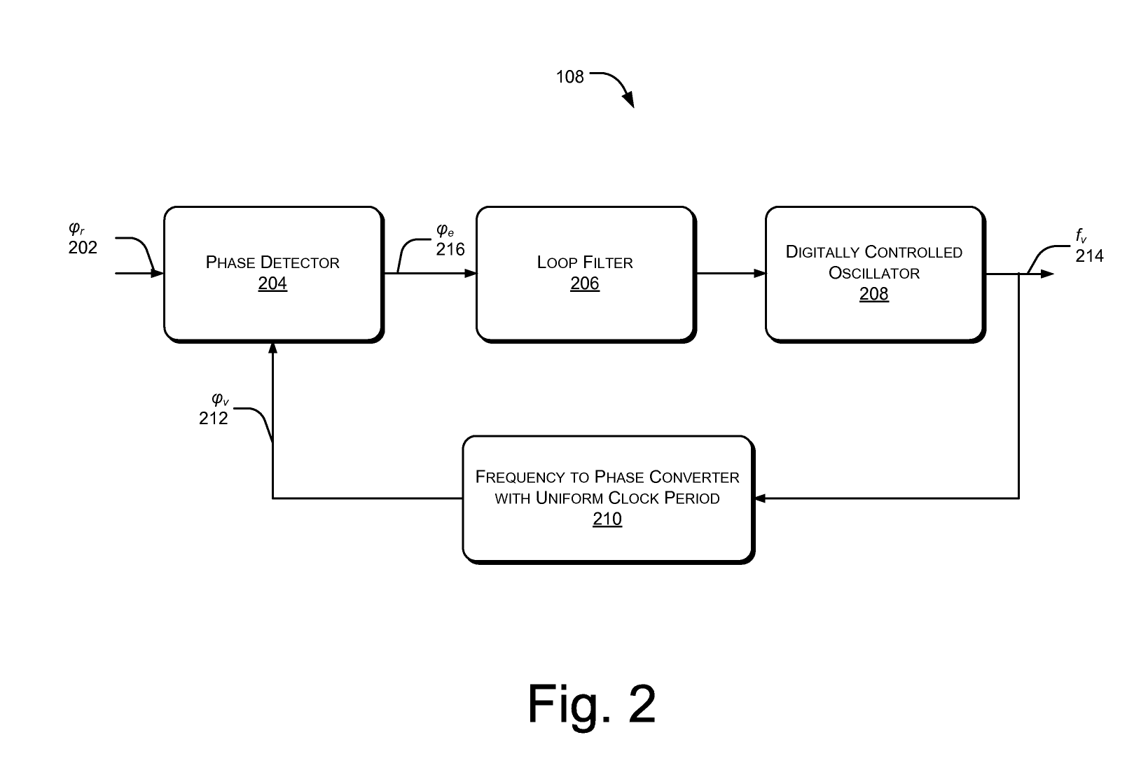

The low noise amplified signal from the LNA 104 is received by mixer 106. The mixer 106 may be a non-linear circuit or device that accepts two different frequencies, and having an output that is a mixture of signals at several frequencies. The mixer 106 may be used in the system 100 in order to convert the RF input signal into an intermediate frequency (IF) signal. An input to the mixer 106 is the input RF signal, while another input is the output of the ADPLL 108. The ADPLL 108 provides precise and controlled frequency signals using a uniform sampling frequency to phase converter (i.e., uniform/constant clock period). The operation of the ADPLL 108 is described in detail with reference to FIGS. 2-5.

The mixer 106 produces a summation signal, a difference signal, and the actual (i.e., data) signals. The filter 110 filters out other signals and passes the difference IF signal (i.e., provides a filtered signal). The filter 110 may be an analog filter or a digital filter, depending on design/use of the system 100.

The filtered signal is amplified using the amplifier 112 and sent to the demodulator 114. Depending on the modulation technique used to modulate the filtered signal, a corresponding demodulator 114 may be implemented in the receiver 100. For example, in case of a GSM modulated signal, the demodulator 114 may be an I/Q demodulator. Furthermore, the system 100 may include other devices, such as analog to digital converters, digital to analog converters, loudspeakers, digital signal processors, and other devices, that do not limit the operation of the system 100.

FIG. 2 illustrates an exemplary ADPLL 108 with uniform sampling frequency to phase converter or FPC 210. The ADPLL 108 is a control system that generates an output signal that has a fixed relation to the phase of a input reference signal φᵣ 202. The ADPLL 108 may automatically raise or lower the frequency of a controlled oscillator (as discussed further below), until the DCO output signal is matched to a reference signal in both frequency and phase. To this end, the ADPLL 108 includes a phase detector 204, a loop filter 206, a DCO 208, and the FPC with a uniform or constant clock period 210 or FPC 210.

In an implementation with uniform sampling frequency f_{ref} with time index n, the reference phase signal φᵣ[n] 202, along with a phase feedback signal φᵥ[n] 212, is received by the phase detector 204. The phase feedback signal φᵥ[n] 212 is obtained by converting a frequency signal fᵥ 214 generated by the DCO 208, into a digital phase signal using the FPC with uniform sampling 210. The phase detector 204 may be digital logic that generates an error phase signal φₑ[n] 216, which represents the difference in phase between the digital reference phase signal φᵣ[n] 202 and the digital feedback phase signal φᵥ[n] 212.

The loop filter 206 is placed after the phase detector 204 in order to filter the error phase signal φₑ[n] 216. The loop filter 206 is a digital filter that converts the error phase signal φₑ[n] 216 into a low-pass filtered digital output Nᵥ[n]. Since the loop filter 206 is digital, its parameters are digital. Therefore, the parameters of loop filter 206 may be easily changed. Furthermore, the loop filter 206 is not expected to suffer from thermal noise, aging, and/or drift. The loop filter 206 may be formed using counters (i.e., up/down counters, N-before-M counters, K-counters, etc.).

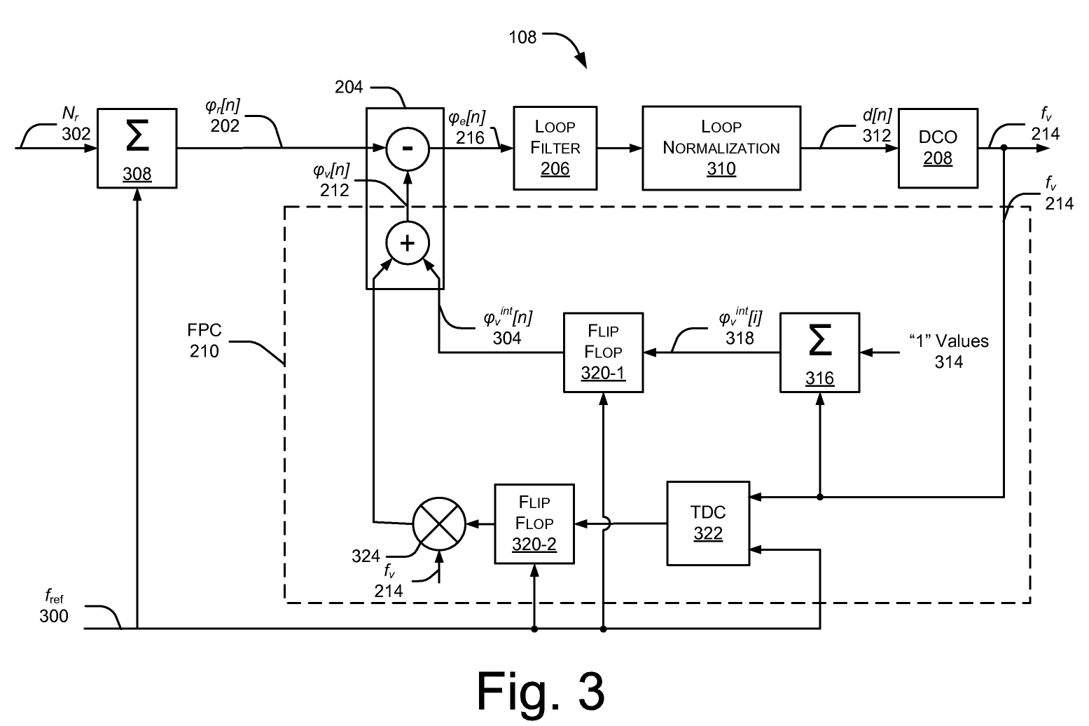

The generated frequency signal fᵥ 214 is converted into the digital feedback phase signal φᵥ[n] 212, which is then compared with the phase of the digital reference signal φᵣ[n] 202. The FPC 210 is employed to do the conversion. The FPC 210 is a uniform sampling converter that avoids retiming of the reference clock, which allows the entire system to be clocked with a uniform sampling frequency, or in other words, constant or uniform clock periods. The operation of the FPC 210 is discussed in further detail below in reference to FIGS. 3-5.

FIG. 3 illustrates an exemplary ADPLL 108 in greater detail. Furthermore, FIG. 3 shows an implementation of the FPC 210 as a synchronous clocking mechanism that may avoid retiming of the reference clock. The FPC 210 converts the DCO generated frequency signal fᵥ 214 into the digital feedback phase signal φᵥ[n] 212 to be compared with the digital reference signal φᵣ[n] 202.

The reference frequency to phase conversion may be performed in a relatively easier manner, because a reference frequency f_{ref} 300 is assumed to be exact, while the information on the variable phase φᵥ 212 is extracted from its physical oscillation in the complex mixed signal feedback path. The reference phase φᵣ[n] 202 may be calculated by accumulating Nᵣ 302 at the rate of the reference frequency, where Nᵣ 302 is the frequency command word that corresponds to the ratio between variable and reference frequency, or in other words, to the desired number of variable periods within one reference period. It is to be noted that Nᵣ 302 may be a fractional number.

The conversion in the feedback path 210 is carried out at a uniform rate that may be similar to the rate of the reference frequency f_{ref} 300. The FPC 210 may convert and separate the generated frequency signal fᵥ 214 into an integer phase signal φᵥ^{int}[n] 304 and a fractional phase signal φᵥ^{frac}[n] 306. The signals φᵥ^{int}[n] 304 and φᵥ^{frac}[n] 306 are added up to produce φᵥ[n] 212, which is then sent to phase detector 204 for subtraction. In the described implementation the integer part φᵥ^{int}[n] 304 is measured by accumulating “1” value 314 at the rate of the variable frequency fᵥ 214 and sampled with the reference clock f_{ref} 300. The fractional part φᵥ^{frac}[n] 306 (described in more detail below) may be measured with the aid of a time to digital converter, a multiplier, a flip-flop. However, other implementations of equivalent behavior are feasible. The TDC 322 may be implemented in different forms, for example, an implementation is to use an array of inverters with one inverter delay as quantization step.

The signal input to the ADPLL 108 in FIG. 3 is the frequency command word Nᵣ 302, which defines the desired output signal of the ADPLL 108 as a multiple of a reference frequency signal f_{ref} 300, such that the desired frequency signal fᵥ^{SS} is defined by the following equation:

fᵥ^{SS}=f_{ref}Nᵣ (1)

An accumulator 308 converts the frequency command word Nᵣ 302 into the reference phase signal φᵣ[n] 202. The reference phase signal φᵣ[n] 202 is fed to the phase detector 204, where the reference phase signal φᵣ[n] 202 is compared with the variable phase signal φᵥ[n] 212.

The output of the phase detector 204 is the error phase signal φₑ[n] 216. The error phase signal φₑ[n] 216 represents the variation in the feedback signal φᵥ[n] 212 in comparison with the reference phase signal φᵣ[n] 202. In other words, the slope of both ramp (i.e., phase) signals must be equal to achieve a constant phase error φₑ[n] 216, and consequently lock or stabilized. The phase error signal φₑ[n] 216 may be filtered by the loop filter 206.

The filtered error phase signal is fed to a loop normalization block or circuit 310. The loop normalization block or circuit 310 multiplies the filtered error phase signal with the reference signal f_{ref} 300, because an integer change of the input Nᵣ should correspond to a change of f_{ref} 300 in the variable frequency fᵥ 214, and normalizes the resultant signal by an estimate of the DCO 208 gain to make it ideally independent of PVT effects; however, since the DCO 208 may suffer from changes in the environment, the DCO 208 gain estimate may be updated from time to time.

The signal obtained after loop normalization and gain normalization is a digital word signal d[n] 312. The DCO 208 generates the frequency signal fᵥ 214 corresponding to the digital word signal d[n] 312. The DCO 208 converts the digital input word d[n] 312 that corresponds to the error phase signal φₑ[n] 216, into an analog frequency signal fᵥ 214. A part of the generated signal fᵥ 214 is fed back to the phase detector 204 in order to compare the phase of this signal with the digital reference signal φᵣ[n] 202. It is to be noted, that the digital nature of the ADPLL 108 allows various realizations with equivalent behavior.

The DCO 208 generated frequency signal fᵥ 214 is sent to the FPC 210. The FPC 210 converts the variable frequency signal fᵥ 214 into a variable phase signal φᵥ[n] that is separated into the integer phase signal φᵥ^{int}[n] 304 and the fractional phase signal φᵥ^{frac}[n] 306. The integer phase signal φᵥ^{int}[n] 304 is calculated by accumulating digital value one or “1” 314 at the rate of the generated frequency signal fᵥ 214 in an accumulator 316, and converting the analog generated frequency signal fᵥ 214 into a digital phase signal φᵥ^{int}[i], where i corresponds to the variable frequency fᵥ 214. In an implementation, the output of the accumulator 316 is re-sampled at flip-flop 320-1 by the reference signal f_{ref} 300 to produce φᵥ^{int}[n] 304.

Since the frequency command word Nᵣ 302 may be a fractional number, integer accuracy is not sufficient for communication systems. The reference signal f_{ref} 300 and the generated frequency signal fᵥ 214 may have different frequencies and their rising edges may not be synchronized. The fractional part of the feedback signal φᵥ^{frac}[n] 306 is obtained differently from the integer part φᵥ^{int}[n] 304. In an implementation, the generated frequency signal fᵥ 214 is fed to a time to digital converter or TDC 322 along with the reference signal f_{ref} 300.

The TDC 322 calculates the time from the rising edge of the generated frequency signal fᵥ 214 until the rising edge of the reference signal f_{ref} 300. The TDC 322 converts the calculated time into a digital signal. The digital signal is sent to a second flip-flop 320-2. The digital signal is sampled using the reference signal f_{ref} 300. The sampled digital signal is fed to a multiplier 324. At the multiplier 324, the sampled digital signal is normalized by the period of the variable frequency signal fᵥ 214, since integer part of the variable phase φᵥ^{int}[n] 304 calculates the phase with respect to variable periods. The signal ξ[n] 326 equals the fractional phase signal φᵥ^{frac}[n] 306 of the feedback phase signal φᵥ[n] 212.

The obtained integer part φᵥ^{int}[n] 304 and fractional part φᵥ^{frac}[n] 306 of the feedback phase signal 212 are added up to produce φᵥ[n] 212, where subtraction is performed by the phase detector 204. In an implementation, the signal φᵥ[n] 212 is the output of the uniform frequency to phase converter 210 and is then fed to the phase detector 204. In other words, at the phase detector 204, φᵥ[n] 212 is subtracted from the reference phase signal φᵣ[n] 202 to obtain the error phase signal φₑ[n] 216. In certain implementations, the phase detector 204 may be a part of the FPC 210.

Therefore, without the need for oversampling the reference frequency f_{ref} 300 by the variable frequency signal fᵥ 214, the variable frequency signal fᵥ 214 is converted into the feedback phase signal φᵥ[n] 212. Since the reference signal f_{ref} 300 retiming is not carried out, the generation of side spurs may be eliminated in a uniformly sampled ADPLL 108.

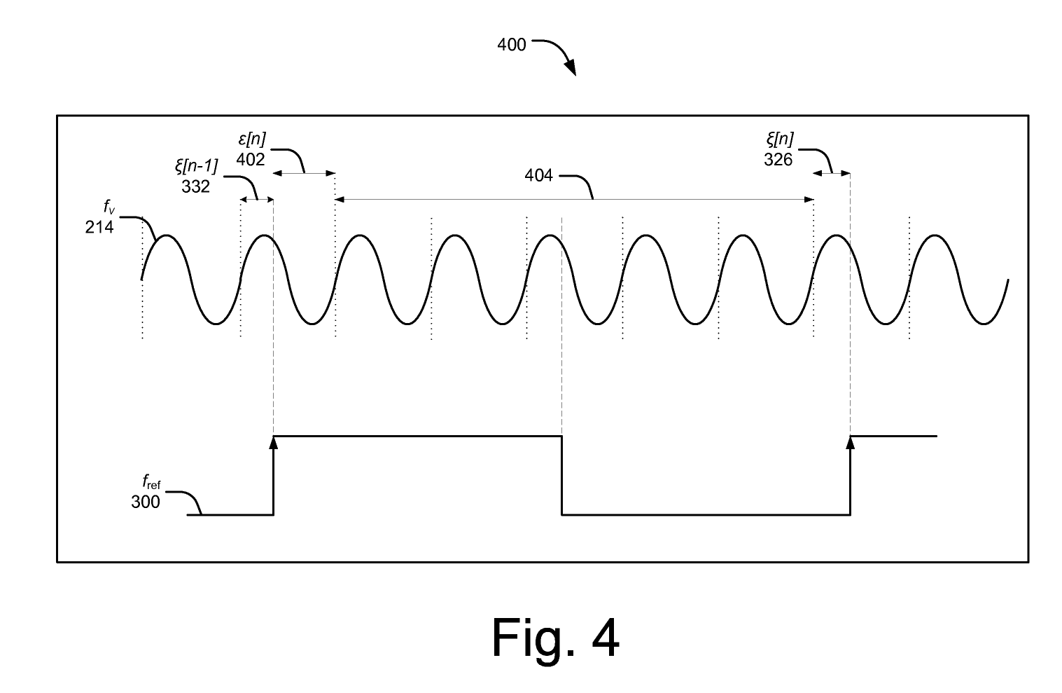

FIG. 4 illustrates an exemplary timing diagram 400 of a variable signal and a reference signal. Timing diagram 400 describes the relation between the reference signal f_{ref} 300 and the generated frequency signal fᵥ 214. The generated frequency signal fᵥ 214 has a higher frequency than the reference signal f_{ref} 300, and depicts the relation between the various time measurements of the two signals. The normalized signal ξ[n] 326 represent the time from the rising edge of the generated frequency signal fᵥ 214 until the rising edge of the reference signal f_{ref} 300 normalized to one period of fᵥ 214.

### Synchronous Timing Mechanism of the ADPLL

In each reference cycle the frequency to phase converter increases by a value of Nᵥ[n]. The digital signal Nᵥ[n] corresponds to the actual relation between the generated signal fᵥ 214 and reference signal f_{ref} 300 of the previous clock cycle. In steady state, the digital signal Nᵥ[n] may converge in steady-state to Nᵣ. Accordingly, the variable phase φᵥ[n] 212 is theoretically given by accumulating Nᵥ[n], as represented by the following equation:

$${ϕ}_{v} [ n ] = {\sum }_{l = 0}^{n} {N}_{v} [ l ] = {\sum }_{l = 0}^{n} \frac{{f}_{v} [ l ]}{{f}_{ref}} \qquad ( 2 )$$

The digital signal Nᵥ[n] may be split into an integer part N^{int}ᵥ[n] 404 and a fractional part N^{frac}ᵥ[n], as represented by the following equation:

Nᵥ[n]=Nᵥ^{int}[n]+Nᵥ^{frac}[n] (3)

Substituting equation (3) into equation (2) results in the following equation:

$${ϕ}_{v} [ n ] = {\sum }_{l = 0}^{n} {N}_{v}^{int} [ l ] + {\sum }_{l = 0}^{n} {N}_{v}^{frac} [ l ] \qquad ( 4 )$$

As discussed above, in the feedback loop, the FPC 210 separates and converts the generated signal fᵥ 214 into the integer phase signal φᵥ^{int}[n] 304 and the fractional phase signal φᵥ^{frac}[n] 306. The integer part φᵥ^{int}[n] 304 is calculated by accumulating digital “ones” or “1” at the generated signal fᵥ 214 rate and resampled by the reference signal f_{ref} 300, as represented by the following equation:

$${ϕ}_{v}^{int} [ n ] = {\sum }_{l = 1}^{i} 1 {\vert}_{{iT}_{v} = [ {nT}_{ref} ]} = {\sum }_{l = 0}^{n} ( {N}_{v}^{int} [ l ] - 1 ) \qquad ( 5 )$$

Counting the rising edges in each reference cycle is equal to the number of full variable periods plus one period, as shown in the right term of equation (5). Calculation of the fractional part N^{frac}ᵥ[n] is different as compared to the integer part, since the generated signal fᵥ 214 and the reference signal f_{ref} 300 have no common domain. FIG. 4 shows the generated signal fᵥ 214 for one reference signal f_{ref} 300 cycle. The fractional part N^{frac}ᵥ[n] includes the initial phase ε[n] 402 and the phase of the last incomplete period ξ[n] 326 as defined by the following equation:

N^{frac}ᵥ[n]=ε[n]+ξ[n] (6)

It is noted that ξ[n] 326 is the time from the rising edge of the generated signal fᵥ 214 until the rising edge of the reference signal f_{ref} 300 normalized by Tᵥ. The initial phase ε[n] 402 is the time from the rising edge of the reference signal f_{ref} 300 until the next rising edge of the generated signal fᵥ 214 normalized by Tᵥ. In an implementation, if Nᵥ[n] is equal to Nᵥ[n−1] for the particular moment, the value of the initial phase ε[n] may be defined by the following equation:

ε[n]=1−ξ[n−1] (7)

Even if Nᵥ[n]≠Nᵥ[n−1], the relation in equation (7) will be approximately correct. The time signal ξ[n] 326 may be measured by the TDC 322. Substituting equation (7) into equation (6) and accumulating N^{frac}ᵥ[n] provides the following equation:

$${\sum }_{l = 0}^{n} {N}_{v}^{frac} [ l ] = {\sum }_{l = 0}^{n} ( ɛ [ l ] + 1 - ξ [ l - 1 ] ) \qquad ( 8 )$$

Substituting equation (7) into equation (8), it is determined that the accumulation cancels the difference, assuming that ξ[−1]=0. It is contemplated, that in practice any deviation is a constant error and compensated by the feedback of the ADPLL, as defined by the following equation:

$${ϕ}_{v}^{frac} [ n ] = {\sum }_{l = 0}^{n} ξ [ l ] - ξ [ l - 1 ] = ξ [ n ] \qquad ( 9 )$$

The variable phase is defined as the sum of φᵥ^{int}[n] 304 is defined by equation (5) and φᵥ^{frac}[n] 306 is defined by equation (9), and resulting in the following equation:

φᵥ[n]=φᵥ^{int}[n]+φᵥ^{frac}[n] (10)

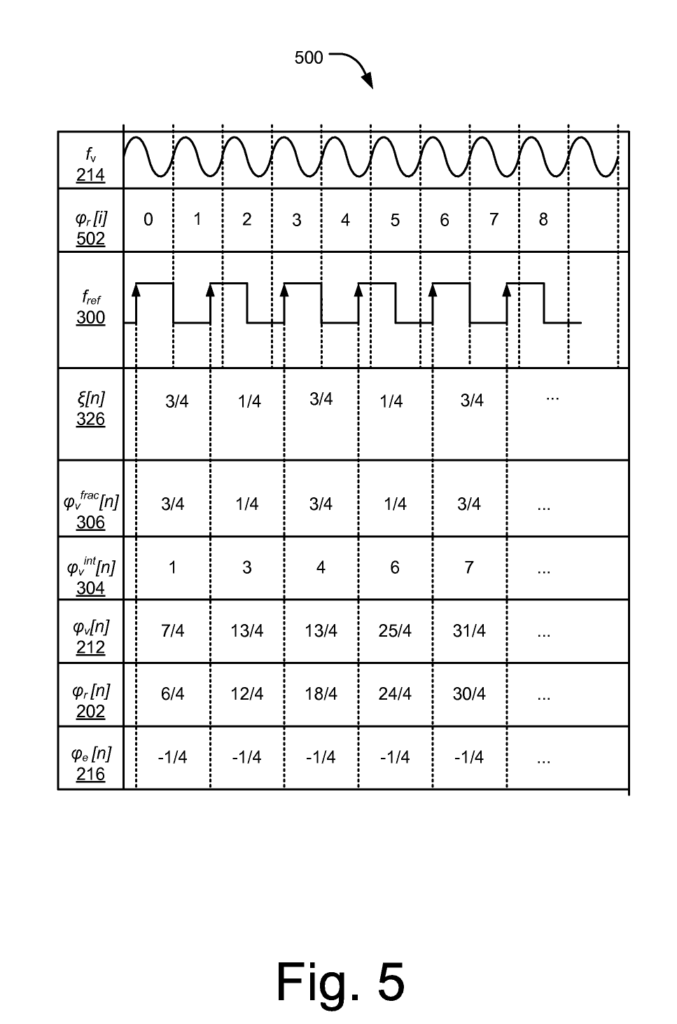

FIG. 5 illustrates an exemplary timing diagram 500 of the ADPLL 108. The timing diagram 500 shows the relation between various signals generated in the ADPLL 108 at various stages. The timing diagram 500 may be used to describe the operation of the ADPLL 108. In the example, the command word Nᵣ 302 is 1.5; however, it is noted that command word Nᵣ 302 may be any other value which is typically much larger, and is only the value of “1.5” is used as an exemplary value here to describe the timing diagram 500.

The generated frequency signal fᵥ 214 is illustrated along with a reference phase 502. The reference phase 502 is a digital signal that increments with every clock cycle. The reference signal f_{ref} 300 is also a digital clock signal.

The normalized signal ξ[n] 326 is the time between the rising edges of the generated signal fᵥ 214 until the rising edges of the reference signal f_{ref} 300. This signal is measured by the TDC 322 in order to obtain the fractional part φᵥ^{frac}[n] 306 of the feedback signal φᵥ[n] 212. As timing diagram 500 shows in the first instance, ξ[n] 326 is ¾ of the generated signal fᵥ 214. In the second instance that ξ[n] 326 is measured, ξ[n] 326 is ¼ of the generated signal fᵥ 214, and so on.

The next value in FIG. 5 is the fractional phase signal φ^{frac}ᵥ[n] 306, which equals ξ[n] 326. (Alternatively, the fractional phase error may be computed by accumulating the difference between ξ[n] 326 and its delayed version ξ[n−1], which would be constantly ½.)

The integer phase signal φᵥ^{int}[n] 304 of the feedback signal φᵥ[n] 212 is described. The integer phase signal φᵥ^{int}[n] 304 is the number of complete cycles of the generated signal fᵥ 214 before the next rising edge of the reference signal f_{ref} 300. The integer phase signal φᵥ^{int}[n] 304 in the first instance is a value of 1. In the second instance, the integer phase signal φᵥ^{int}[n] 304 is a value of 3, in the third instance it is a value of 4, and so on.

Therefore, the total phase of the feedback signal φᵥ[n] 212 is, 1.5, 3, 4.5, 6, etc. Since with the reference signal f_{ref} 300 the command word 202 Nᵣ=1.5 is accumulated, the reference phase φᵣ[n] 202 is 1.5, 3, 4.5, 6, etc.

The error phase signal φₑ[n] 216 is the difference between the phase of the digital reference phase signal φᵣ[n] 202 and the phase of the feedback signal φᵥ[n] 212. In this example, the phase error signal φₑ[n] 216 is constantly −¼.

### Exemplary Method

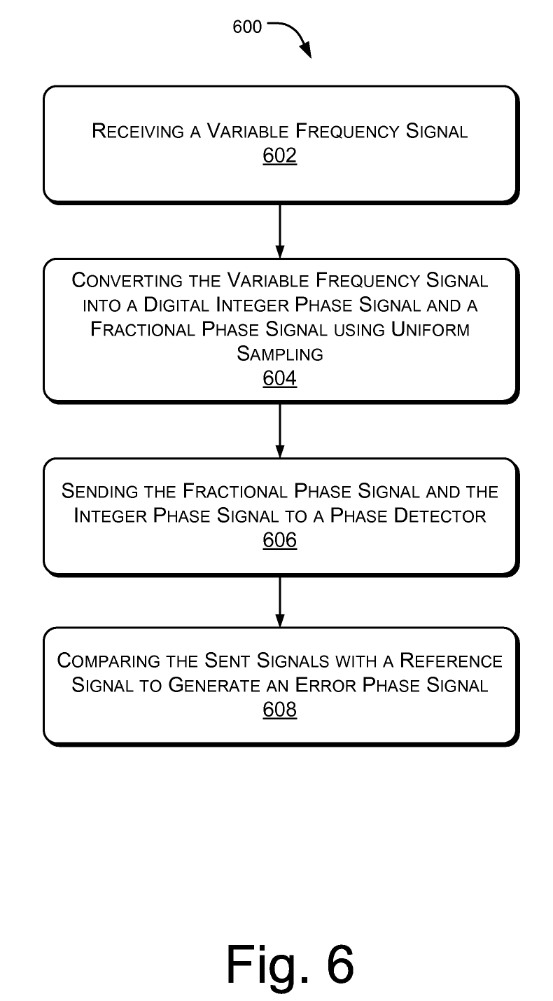

FIG. 6 illustrates an exemplary method 600 to convert a frequency feedback signal into a phase signal using uniform sampling, where the uniform sampling includes the use of a constant clock period reference signal. In one implementation, the exemplary method 600 can be implemented in the ADPLL 108. The exemplary method 600 is described with reference to FIGS. 1-5. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method can be implemented in any suitable hardware, software, firmware, or a combination thereof, without departing from the scope of the invention.

At block 602, receiving a frequency feedback signal is performed, using a constant clock period reference signal. This may be performed by the exemplary ADPLL devices and systems as discussed above. The receiving may include receiving the frequency feedback signal corresponding to an error signal of a previous cycle.

At block 604, converting the frequency feedback signal into a digital phase signal is performed. This is particularly performed by uniformly sampling the frequency feedback signal with a uniform reference signal, where the reference signal is a constant clock period reference signal. Furthermore, the frequency feedback signal may be separated into an integer phase signal and a fractional phase signal. The integer phase signal may be obtained by converting the frequency feedback signal into a digital signal and uniformly sampling the digital signal with the uniform reference signal. In an implementation, the fractional phase signal may be obtained by measuring a time difference between rising edges of the frequency feedback signal and the uniform reference frequency signal; converting the time difference into a digital signal; sampling the digital signal with the uniform reference frequency signal; normalizing the sampled digital signal; comparing the normalized digital signal with a time delayed version of the normalized digital signal; and accumulating the compared signal to obtain the fractional phase signal. The uniform sampling may be a synchronous clocking mechanism.

At block 606, sending the fractional phase signal and integer phase signal to a phase detector is performed.

At block 608, comparing the digital phase signal with a reference phase signal is performed to generate an error phase signal. The reference phase signal may be obtained by multiplying the uniform frequency signal with a frequency command word and converting the multiplied signal into a phase signal.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as preferred forms of implementing the claims. For example, the systems described could be configured as monitoring circuits and incorporated into various feedback and control loops.

What is claimed is:

1. A frequency to phase converter that converts an input signal with an arbitrary frequency into a output phase signal, wherein the output phase signal is a time-domain signal having a constant or uniform period.

2. The frequency to phase converter of claim 1, wherein the input signal is a clock signal and the output phase signal is a digital signal.

3. The frequency to phase converter of claim 1, wherein the frequency to phase converter uses a synchronous clocking mechanism with the input signal to create the output phase signal.

4. The frequency to phase converter of claim 1, wherein a period of the output phase signal is given by a reference clock signal with a uniform clock period.

5. The frequency to phase converter of claim 1, wherein the frequency to phase converter comprises one or more of the following: a flip-flop, a time to digital converter, and a multiplier.

6. The frequency to phase converter of claim 1, wherein the output phase signal is a digital phase feedback signal that is separated in two or more intermediate signals.

7. The frequency to phase converter of claim 1, wherein the output phase signal is a digital signal that includes a digital phase separated into an integer phase signal and a fractional phase signal.

8. The frequency to phase converter of claim 7, wherein the integer phase signal is obtained by converting the arbitrary frequency into a digital signal and sampling the digital signal by the constant or uniform period.

9. The frequency to phase converter of claim 7, wherein the integer phase signal is converted from the arbitrary frequency by accumulating a digital value at the rate of the variable frequency signal.

10. The frequency to phase converter of claim 7, wherein the fractional phase signal is obtained by comparing rising or falling edges of a reference clock signal and the arbitrary frequency to obtain a digital signal used to calculate the fractional phase signal.

11. The frequency to phase converter of claim 7, wherein the fractional phase signal is obtained by comparing the rising or falling edges of the reference clock signal and the arbitrary frequency to obtain a digital signal used to calculate the fractional phase signal.

12. The frequency to phase of claim 7, wherein the fractional phase is produced by measuring a time between a reference clock signal and a variable clock signal for each reference cycle and normalizing the time.

13. The frequency to phase converter of claim 7, wherein the fractional phase is produced by a time to digital converter.

14. The frequency to phase converter of claim 7, wherein the fractional phase is produced by accumulating an initial fractional phase and a final fractional phase.

15. The frequency to phase converter of claim 14, wherein the initial fractional phase signal is obtained by:
measuring a time difference between edges of a frequency feedback signal and the reference clock signal at a beginning of a reference period;
converting the time difference into a digital signal;
sampling the digital signal with the reference clock signal into a sampled digital signal; and
normalizing the sampled digital signal into a normalized digital signal.

16. The frequency to phase converter of claim 14, wherein the final fractional phase signal is obtained by:
measuring a time difference between edges of a frequency feedback signal and the reference clock signal at an ending of a reference period;
converting the time difference into a digital signal;
sampling the digital signal with the uniform reference frequency signal into a sampled digital signal; and
normalizing the sampled digital signal into a normalized digital signal.

17. The frequency to phase converter of claim 14, wherein the initial fractional phase and final fractional phase are measured by a time to digital converter.

18. The frequency to phase converter of claim 14, wherein the initial fractional phase is computed from the final fractional phase signal.

19. The frequency to phase converter of claim 14, wherein the final fractional phase is computed from the initial fractional phase signal.

20. An all-digital phase locked loop (ADPLL) comprising:
a reference clock signal with uniform clock period;
a phase detector that compares a reference phase signal and a digital phase feedback signal defined in time domain with the uniform clock period, and generates an error phase signal;
a digital loop filter that filters the error phase signal;
a digitally controlled oscillator that generates a variable frequency signal corresponding to the error phase signal; and
a frequency to phase converter that converts the variable frequency signal into the digital phase feedback signal defined in time domain with the uniform clock period.

21. The ADPLL of claim 20, wherein the reference clock signal is determined by accumulating a frequency command word at a frequency rate of the reference phase signal.

22. The ADPLL of claim 20, wherein the phase detector receives a reference phase and a phase feedback signal and computes a phase error signal.

23. The ADPLL of claim 20, wherein the phase detector performs a subtraction.

24. The ADPLL of claim 20, wherein the digital loop filter includes one or more counters.

25. The ADPLL of claim 20, wherein the digitally controlled oscillator generates the variable frequency signal corresponding to a digital word signal.

26. The ADPLL of claim 20, wherein the frequency to phase converter receives the variable frequency signal from the digitally controlled oscillator, and converts the variable frequency signal to a phase feedback signal defined in time domain with a uniform clock period.

27. The ADPLL of claim 20, wherein the frequency to phase converter separates the phase feedback signal into a fractional phase signal and an integer phase signal.

28. The ADPLL of claim 20, wherein the frequency to phase converter further converts an input signal with an arbitrary frequency into a output phase signal, wherein the output phase signal is a time-domain signal having a constant or uniform period.

29. The ADPLL of claim 28, wherein the output phase signal is a digital signal that includes a digital phase separated into an integer phase signal and a fractional phase signal.

30. The ADPLL of claim 29, wherein the fractional phase is produced by accumulating an initial fractional phase and a final fractional phase.

31. The ADPLL of claim 20 further comprising a loop normalization circuit that normalizes a filtered error phase signal output by the digital loop filter with the reference phase signal.

32. The ADPLL of claim 20, wherein the ADPLL is implemented as part of one of the following: a wireless communication system, Bluetooth device, or wideband device.

33. A system that includes the ADPLL of claim 20, wherein the system is clocked by a clock with a uniform period.

34. A method for converting a frequency feedback signal into a phase signal comprising:
receiving the frequency feedback signal;
converting the frequency feedback signal into a digital phase signal with a uniform reference frequency signal; and
comparing the digital phase signal and a reference phase signal to generate an error phase signal.

35. The method of claim 34, wherein the receiving includes receiving the frequency feedback signal corresponding to an error phase signal of a previous cycle.

36. The method of claim 34, wherein the frequency feedback signal is converted into the digital phase signal by separating the frequency feedback signal into an integer phase signal and a fractional phase signal.

37. The method of claim 34, wherein the integer phase signal is obtained by converting the frequency feedback signal into a digital signal and uniformly sampling the digital signal with the uniform reference frequency signal.

38. The method of claim 34, wherein the fractional phase signal is obtained by:
measuring a time difference between rising edges of the frequency feedback signal and the uniform reference frequency signal;
converting the time difference into a digital signal;
sampling the digital signal with the uniform reference frequency signal into a sampled digital signal;
normalizing the sampled digital signal into a normalized digital signal;
comparing the normalized digital signal with a time delayed version of the normalized digital signal into a compared signal; and
accumulating the compared signal to obtain the fractional phase signal.
